(19) United States
(12) Patent Application Publication
(10) Pub. No.: US 2002/0051541 A1
(43) Pub. Date: May 2, 2002

(54) System and method for maintaining state between a client and server

(76) Inventors: Barry J. Glick, Washington, DC (US); Ronald S. Karpf, Gaithersburg, MD (US); Mark E. Seiler, Los Angeles, CA (US)

Correspondence Address: O'MELVENY & MYERS LLP, 400 So. Hope Street, Los Angeles, CA, 90071-2899, US

(21) Appl. No.: 09/880,308

(22) Filed: Jun. 13, 2001

Related U.S. Application Data
(63) Continuation-in-part of application No. 09/758,637, filed on Jan. 10, 2001.
Application No. 09/758,637 is a continuation-in-part of application No. 09/699,832, filed on Oct. 30, 2000.

(51) Int. Cl. H04K 1/00

(52) U.S. Cl. 380/258

(57) ABSTRACT

A method and apparatus for maintaining state between a client and server while protecting security and privacy allows the server to monitor and maintain a record of the client's current transaction status via a unique identifier. Generally, the client generates a unique identifier, which it transmits to web applications on remote servers during transactions. The web applications can track a series of continuous and related requests using this identifier to better serve the client. Thus, by maintaining state with web applications, the clients can take advantage of increased services than otherwise possible operating in a stateless protocol. However, the client is able to periodically change this identifier when the user desires anonymity.

### RELATED APPLICATION DATA

This is a continuation-in-part of copending patent application Ser. No. 09/758,637, filed Jan. 10, 2001, for CRYPTOGRAPHIC SYSTEM AND METHOD FOR GEOLOCKING AND SECURING DIGITAL INFORMATION, which is a continuation-in-part of copending patent application Ser. No. 09/699,832, filed Oct. 31, 2000, for SYSTEM AND METHOD FOR USING LOCATION IDENTITY TO CONTROL ACCESS TO DIGITAL INFORMATION.

### BACKGROUND OF THE INVENTION

1. Field of the Invention

The present invention relates to systems and methods for maintaining state between a client and server through the use of unique identifiers.

2. Description of Related Art

Rapid advances in computer, telecommunications and networking technology have enabled an avalanche of new opportunities and applications that were impossible just a few years ago. These advances are exemplified by the explosive growth in popularity of the Internet. As known in the art, the Internet is an interconnection of computer networks that enables computers of all kinds to communicate with each other and share information. Companies, individuals, government agencies, charitable organizations, and academic centers, of all sizes, regularly use the Internet to share information, deliver services, and exchange a wide range of content. The Internet functions as a distributed network of systems that is neither controlled nor managed by any one entity. Physical and logical pathways that facilitate the exchange of information connect these networks to each other.

As the technology used to construct the Internet has increased in complexity and sophistication, user interactions on the Internet have evolved in much the same way. Whereas the Internet was once merely a communications medium for people in academia and government, it has become a center for commerce, a place of learning, a social setting, and more to the general populace. However, because the Internet is a public construct, user interactions on the Internet may be monitored and recorded, often unbeknownst to the user. Therefore, one of the most important considerations for continued expansion of the Internet is the control over information security and access.

Common user interaction on the Internet involves web applications hosted by remote servers connected to the Internet. Web applications generally receive user requests and respond by displaying the requested information. They were originally developed to obtain information from multiple sources and then display the information in what appeared to users to be a single document. For example, if a user were to request instructions on car repair, the web application might obtain a graphic image from one source and the related text from another source, and then display them as a single document. However, this method of displaying information to users was limiting, and it was not long before “extensions” of web functionality were developed to store “richer” web pages. Thus, web developers could embed multiple files into a single document.

To further expand the functionality of web applications on the Internet, web developers also created the concept of “state.” In other words, web applications would have the ability to retain a record of a user's prior transactions and utilize that record to more effectively serve that user. The hypertext transfer protocol (“http”) that generally governs communications between clients and servers on the Internet is considered to be a “stateless” protocol. Thus, when a client makes a series of requests for resources from a server, that server retains no record of the requests. Each request for information opens a new connection between the client and server. When the information is received, the connection is terminated without any record that the interaction occurred. While “stateless” interactions are generally required for servers to provide efficient access to numerous users due to resource constraints, this very absence of state limits the functionality web applications can provide. Some web applications require that sequential client requests be tracked from one page to another. For instance, a website selling retail goods may use a “shopping cart” application that allows clients to select multiple items from different web pages and pay for them in a single transaction. Such an application requires that item selections from previous pages be maintained as the client browses through the website. Therefore, developers worked on different ways for web applications to maintain state.

In traditional programming, there are many ways to maintain persistent information. For example, applications in Windows 3.x utilized an “.ini” file in which application-specific information could be stored. Such information would include system settings and preferences that were unique to the specific computer on which the applications were installed. The “.ini” file could be reset or modified at any time during the operation of the application, such that at its next invocation, the stored settings would be utilized. Further, such persistent information could also be stored in database files or other custom files for similar use. However, due to general security concerns associated with public interactions on the Internet, clients often restrict web application access to machine resources. This limits a web application's ability to use traditional methods for storing persistent information. Thus, web developers had to find a new method for maintaining state.

One method for maintaining state that web developers created was to use “hidden” hypertext markup language (“html”) form fields to pass information between clients and web applications on servers. Hidden html form fields store information that is passed between the client and server, but is hidden from the view of the user. However, although information in these files is hidden, it is not secret because a user may view the information by looking at the html source of the document. Further, this unencrypted information is passed between client and server over a public network enabling others to capture and view it in the same manner. Thus, this method of maintaining state information did not address information security concerns. Finally, use of hidden html form fields within an application is cumbersome, requires significant use of computer resources, and greatly complicates the design, programming and maintenance of web applications.

To further address these problems, Netscape developed “cookies” in 1994 as a more efficient method of maintaining state during Internet transactions. The name was derived colloquially as a reference to the chunks of privileged or secret data that were exchanged between clients and servers to maintain state. Cookies are small, heavily formatted text files, specifically limited in size and number, which enable client-side storage of state information for use with web applications. A given server may store a cookie on the client's computer for use in subsequent transactions. For example, a retail website might store a client's shopping preferences or transactional history using a cookie. Thus, if the client should return to the retail website, the retail website could access the cookie and display products tailored to the client's particular interests.

Basically, the server transmits and causes data to be stored on the client a file that is to be accessed by the server at a later date. When the server calls for the contents of this file at the later date, the client transmits the data back to the server in an http header. Clients typically only limit cookies by size, quantity, and other characteristics related to the client's resource constraints, but not by content. Thus, servers can store information about the client, often private in nature, in these cookies. Further, although clients typically assign time limitations to the storage of cookies, they generally allow them to persist beyond a single browser session. Thus, cookies allow clients and servers to maintain state for an extended period of time.

Notwithstanding the advantages of cookies, the utilization of cookies has been abused by web applications that use cookies without the user's knowledge or consent. A web application can use cookies to track a user's behavior across multiple servers encroaching on the user's privacy. For example, a user visits a website hosted by Company A's server. The server creates and stores a cookie on the user's computer, which contains information about the user's transactions with that website. While use of cookies in this manner is generally acceptable to and expected by the user, Company A may further utilize its cookie through third party servers unbeknownst to the user. When the user visits another website on a different server, Company A can continue to monitor the user's transactions and update its cookie accordingly as long as it has its web application software operating on that server. For instance, Company A may pay for banner advertisements on a variety of popular websites and therefore, may have its web application software on all the servers that host such websites. Thus, Company A can effectively track the user's behavior across multiple servers. Further, Company A may then sell this information about the user to third parties.

In addition to posing risks to a user's privacy, cookies may also pose risks to a user's security. For example, a website may store sensitive information in cookies, such as a user's password, credit card number, or financial account information. Thus, others may find ways to access this information. When a web application calls for the contents of a cookie, the client typically transmits the information in an unencrypted http header, which anyone can intercept as it travels through public networks. Further, others may simply find ways to retrieve cookies from the client even if they did not originally create them. While cookies facilitate a level of convenience that expands utilization of the Internet, they also pose a risk to both user privacy and security.

Consequently, users often disable the cookies option on their browsers to protect themselves. However, such action limits the users' abilities to take advantage of the full functionality offered by the Internet. Therefore, an improved system and method for maintaining state between a client and server is needed that does not sacrifice a user's privacy and security.

### SUMMARY OF THE INVENTION

A method and apparatus in accordance with the present invention allows a client to maintain state with a web application on a remote server while protecting the user's security and privacy. Generally, the client generates a unique identifier, which it transmits to web applications during transactions. The web applications are then able to use this identifier to monitor and maintain a record of user's current transaction status. However, this identifier can be reset to disable the web application's ability to further track the user's behavior.

In an embodiment of the present invention, the client receives location and temporal values from a global positioning system (“GPS”) receiver. The location value corresponds to the approximate geographic location of the client. Generally, this value includes latitude, longitude, and altitude information. The temporal value corresponds approximately to the time at which the user invoked the current Internet browser session. The client reformats these values into character strings of known lengths and then concatenates them together into a single character string to generate a unique state variable. To make the state variable anonymous, the client then mathematically encodes the characters of the unique state variable, which removes information specific to the client from the identifier. The client then transmits this state variable as an http header with each uniform resource locator (“URL”) request. The remote server receiving these requests compares the state variable to a database to determine if the user has a current transaction status that should be taken into account in the server's response. For instance, if the user is purchasing items using a shopping cart application, then the server may have a record of the specific items already selected by the user through previous requests. Thus, the remote server is able to provide the user with more functionality than it otherwise would be able to offer operating in a stateless protocol. However, when the user terminates the current browser session, the client deletes the state variable, which terminates the remote server's ability to monitor the user's activity in future transactions.

A more complete understanding of the system and method for maintaining state between a client and server will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIG. 1 is a diagram illustrating the client-server setup in accordance with an embodiment of the present invention;

FIG. 2 is a block diagram illustrating the derivation of an anonymous state variable cookie in accordance with an embodiment of the present invention;

FIG. 3 is a table illustrating the derivation of an anonymous state variable cookie from GPS receiver information in accordance with an embodiment of the present invention;

FIG. 4 is a table illustrating the data fields that typically comprise a client-side cookie;

FIG. 5 is a table illustrating the components of a client-side cookie and a state variable cookie;

FIG. 6 is a table showing an example of an http header containing the contents of a state variable cookie; and

FIG. 7 is a flowchart illustrating a method for maintaining state between a client and server in accordance with an embodiment of the present invention.

### DETAILED DESCRIPTION OF THE PREFERRED EMBODIMENT

The present invention provides the ability for a client and server to maintain state while protecting the user's privacy and security. Generally, the present invention involves the derivation of a unique identifier from information provided by a GPS receiver at the invocation of an Internet browser session. The client and server use this unique identifier to maintain state during a given browser session. Rather than transmitting potentially sensitive information across public networks, the client transmits this unique identifier to the server with each message to allow the server to identify it. The server is then able to maintain a record of the user's continuing transactions during a browser session, but is not able to monitor the user's behavior beyond that session. In this manner, users are able to take advantage of richer Internet transactions without significantly increasing risk to their privacy and security.

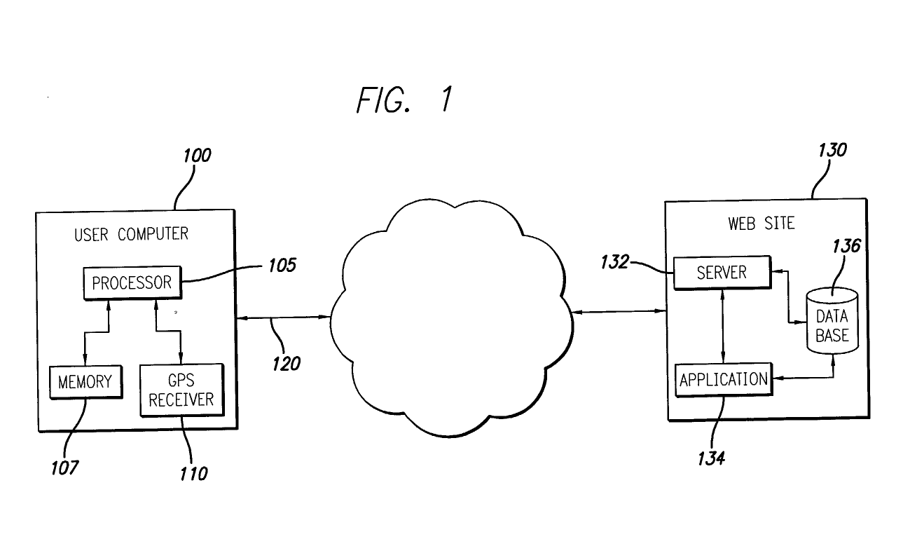

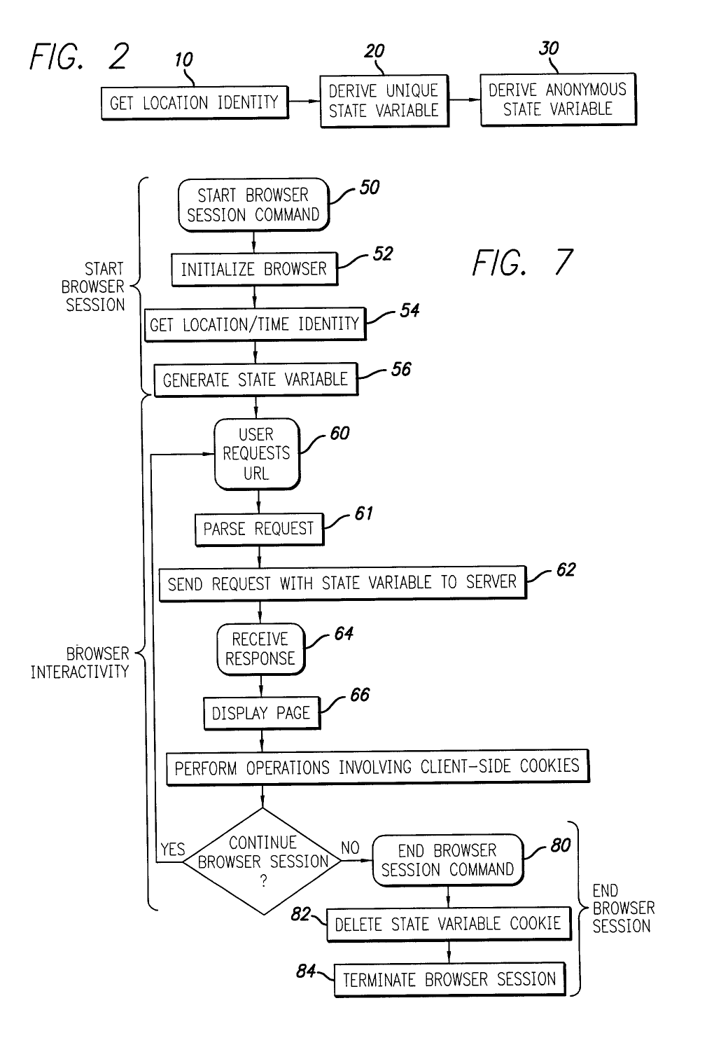

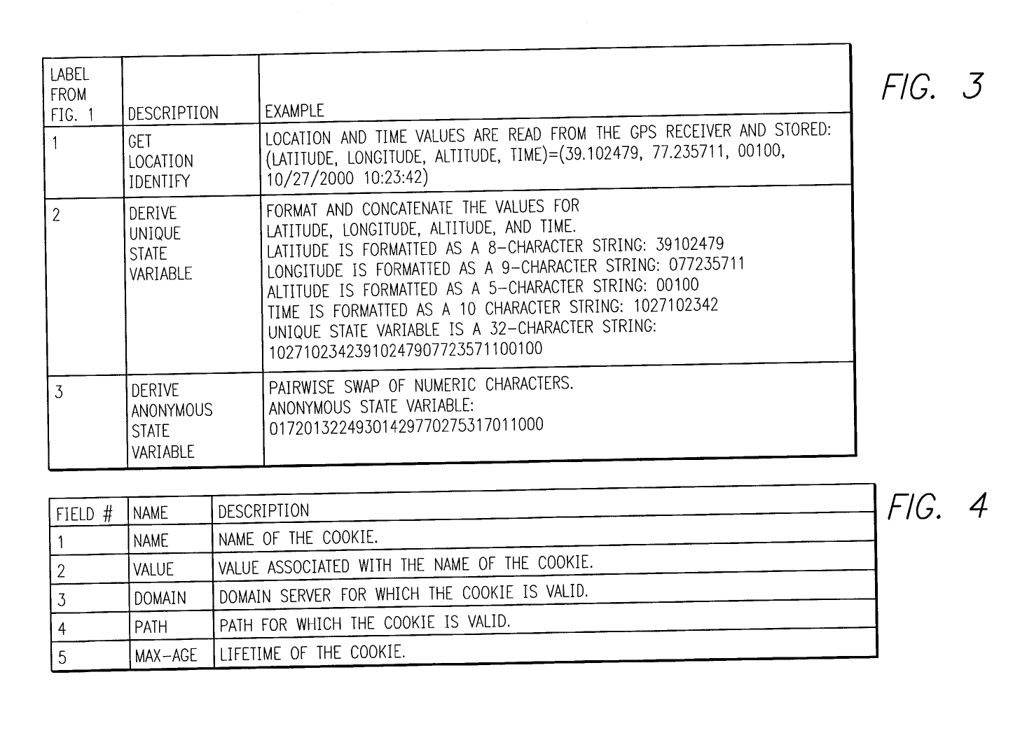

FIG. 1 shows an embodiment of the present invention in apparatus form. The client is user computer 100, which is typically a personal computer comprising processor 105, memory 107, and GPS receiver 110. Optionally, GPS receiver 110 may be externally connected to user computer 100 rather than internally incorporated within it. GPS receiver 110 comprises the hardware and software necessary to receive and decode information from an array of earth-orbiting satellites that provide location and temporal values. User computer 100 further comprises the apparatus necessary to generate a state variable from values received from GPS receiver 110 and to utilize that variable to maintain state with web site 130.

Users interface with web site 130 via network connection 120. Network 120 can be any type of communication medium. For example, network 120 often comprises the communication lines that form the Internet. The underlying components that support web site 130 are server 132, application 134, and database 136. Server 134 is a computer typically located remote to the client, which hosts application 134 and database 136. Application 134 and database 136 provide information and services to the user. One of ordinary skill in the art will appreciate that network 120 can connect users to a variety of different web sites 130 supported by numerous servers 132, applications 134, and databases 136.

Referring to FIG. 2, the block diagram illustrates the derivation of a unique identifier. In one embodiment of the present invention, a client retrieves values related to its location and the time at which the user invoked the Internet browser session at step 10. Although there are a variety of methods for a client to determine these values, the method in this embodiment utilizes a GPS receiver. Currently, there are numerous GPS receivers that have the capability of interfacing with computer systems to relay time and location information. As GPS receiver technology continues to decrease in size and cost, such functionality may eventually become standard equipment within a user's computer system. Regardless of the GPS receiver equipment used, it transmits location and temporal values to the client either periodically or by request. Typically, GPS receivers report output data in NMEA-0183 (“National Marine Electronic Association”) format through a RS-232 interface, or PCMCIA (“Personal Computer Memory Card International Association”) or USB (“Universal Serial Bus”) ports. However, one of ordinary skill in the art would understand that any equipment that facilitates the transfer of data from the GPS receiver to a client in any format recognizable by the client is sufficient.

Once the client has received time and location values from the GPS receiver, it translates this information into a unique state variable that specifically identifies the client at step 20. The client converts the values received from the GPS receiver into strings of variables of known lengths. While the format of each value depends on many factors, including the particular type of GPS receiver used and its units of measurement, this step allows the client to standardize the format of each value. For example, zeroes may be added to the left of the number or a number may be either rounded or truncated to remove characters to the right of the decimal. The client can then concatenate the newly formatted values together into a single character string of known length, which acts as the client's unique state variable for the current browser session. Systems and methods for implementing this step are further described in patent application Ser. No. 09/758,637, filed Jan. 10, 2001, for CRYPTOGRAPHIC SYSTEM AND METHOD FOR GEOLOCKING AND SECURING DIGITAL INFORMATION, and patent application Ser. No. 09/699,832, filed Oct. 31, 2000, for SYSTEM AND METHOD FOR USING LOCATION IDENTITY TO CONTROL ACCESS TO DIGITAL INFORMATION, which are both incorporated herein by reference.

Finally, when increased security and privacy are desired, the client transforms the unique state variable, which still contains easily recognizable location information concerning the client, into an anonymous state variable in which such information is hidden at step 30. The client may use a variety of different mathematical encoding techniques to execute this transformation. By creating its own anonymous identifier to maintain state with servers, the client is able to provide its user with a more secure environment for several reasons. First, the client no longer needs to make its own storage resources available to servers as a prerequisite to maintaining state. Each server stores its own database of information corresponding to unique identifiers and can access that information to search for a match when it receives the client's state variable. Second, the user can change the unique identifier at any time to eliminate any substantive tracking of that user's Internet activities. One of ordinary skill in the art will appreciate that performing step 30 is not necessary to implement the present invention, but that the client may utilize this step to prevent third party servers from determining the geographic location of the client to the extent such information is used to create the unique state variable.

FIG. 3 contains a table that illustrates the previously described steps using a specific example. As shown in the first row of the table, the client receives latitude, longitude, altitude, and time values of 39.102479, 77.235711, 00100, and Oct. 27, 2000 10:23:42, respectively, from the GPS receiver. For the purposes of this example, measurement units have been omitted. The latitude, longitude, and altitude values correspond to a location in Gaithersburg, Md. The time at which the browser session was invoked was Oct. 27, 2000 at 10 hours, 23 minutes, and 42 seconds military time.

As shown in the second row of the table, the client then reformats these values consistent with its internal settings. In this example, the client reformats latitude as an eight-character string, longitude as a nine-character string, altitude as a five-character string, and time as a ten-character string. Thus, the values for latitude, longitude, altitude, and time are reformatted to 39102479, 077235711, 00100, and 1027102342, respectively. Based on this example, the client reformats latitude, longitude, and altitude by removing any decimals and adding zeroes to the left of the number to ensure proper lengths. The number of characters in each reformatted string is chosen to account for all possible situations that may arise. Thus, longitude is a nine-character rather than an eight-character string to account for situations in which the longitude is greater than or equal to 100 degrees. Further, in the case of time, any characters corresponding to the year during which the measurement was taken are truncated. The client then concatenates the newly reformatted values for time, latitude, longitude, and altitude together into a 32-character string that is the unique state variable. One of ordinary skill in the art would understand that the order in which the values are concatenated or the number of values that are concatenated together may be changed.

Finally, as shown in the third row of the table, the client transforms the unique state variable into an anonymous state variable using a pair-wise swapping technique in which adjacent characters that comprise the unique state variable are paired together and swapped. Thus, the identifier, 10271023423910247907723571100100, becomes 01720132249301429770275317011000. However, one of ordinary skill in the art would appreciate that any mathematical coding technique could be used to make the state variable anonymous.

In this embodiment, it is possible for two different computer systems to generate identical state variables if they were placed within the location variance of the GPS receiver equipment used and the state variables are created at the same time. To avoid such situations, the present invention allows for an expansion to any of the recorded values to increase their accuracy. For example, the time character string could be expanded to account for tenths and hundredths of second measurements to decrease the possibility that two identical state variables would be created.

One of ordinary skill in the art would understand that the present invention is not limited in any manner to the embodiment described above. For example, the client may receive location and temporal values from a variety of other techniques and devices, including address geocoding, radio-signal triangulation, wireless Bluetooth zone, and others. Further, the client may use any combination of the values that it receives from such techniques and devices when deriving the client's unique identifier. The values may also be measured at the occurrence of a variety of different triggering events depending on the user's preference. For example, rather than correlating the time value to the user's invocation of a browser session, it could be correlated to a user's execution of a login screen.

FIG. 4 illustrates the general data fields that comprise a cookie file. This includes fields for the name, value, domain, path, and maximum age of the cookie. In the traditional cookie implementation, the server that creates a particular cookie generally assigns it a unique name by which the server calls for the information at a later date. The value field contains the information that the server uses to maintain state with the client. Typically, this field contains information concerning the user's past transactions, preferences, or passwords. The domain and path fields identify the specific website for which the cookie is valid. This prevents other servers from accessing or modifying the cookie. Finally, the maximum age file defines the lifetime of the cookie. After the time specified in this field lapses, the client can discard the cookie.

In an embodiment of the present invention, the state variable cookie conforms to the data field organization of traditional cookies so that it is compatible with all browsers and web applications. The client typically assigns a generic name to this identifier when it is created. For example, the client may reserve the name “StateID” for such cookies. If the client needs to have several different state variable cookies persisting at the same time, then it can reserve multiple names. The value field contains the anonymous state variable, which is transmitted to servers to maintain state. However, the domain and path fields generally remain empty because the state variable cookie is always valid. Finally, the maximum age field is typically set to zero to indicate that the state variable cookie does not persist beyond a single browser session. However, if the user chooses to maintain the same state variable for multiple browser sessions, this field can be changed accordingly.

Further, it is possible for a client to reset its state variable with each new browser invocation, but still maintain state with a server beyond a single browser session. If the client is stationary, then the portion of its state variable that derives from the client's location information will not change between browser invocations unless the mathematical formula used to make the variable anonymous is changed. Thus, a user may consent to maintaining state with a server for an extended period of time by giving the server enough information to allow it to decode the user's state variable. Even then, the user can still regain anonymity by simply changing the mathematical formula used to transform the user's unique state variable into an anonymous state variable.

In another embodiment, the client may generate a unique state variable without transforming it into an anonymous state variable. This unique state variable may be derived from a variety of information, including, as previously discussed, location and time information. Thus, if the user chooses to maintain state with a server over an extended period of time, the user may indicate the portion of the unique state variable that will remain constant over time.

FIG. 5 contains a table that provides specific examples of client-side and state variable cookies. In the client-side cookie example, the file name is derived from the name the user enters into the web application screen and the server domain in which the web application resides. So, in this example, the user is Karpf and the domain is geocodex.com. The .txt extension is generally added to indicate that the file contains text. If no user name were provided, then the client would choose a default name to add to the @geocodex.com.txt identifier. The client then fills in the data fields separating each field with a ˆ signs. Thus, in this example, the cookie is named ShoppingCart and it contains the value, sku001, 1, sku002, 2, sku003, 1, which correspond to three different types of products the user has placed in the shopping cart in quantities of one, two, and one, respectively. Thus, when the user adds another product to the shopping cart, the server can access this cookie to determine a list of all the items that the user has selected for purchase. The domain and path fields indicate that the ShoppingCart cookie is valid for any directory within the geocodex.com domain. Finally, the maximum age field indicates that the client is to store the ShoppingCart cookie for 604,800 seconds or seven days.

In the state variable cookie example, the client uses the generic name StatelD.txt to label the file for storage. As previously discussed, the state variable cookie generally uses the same format as client-side cookies to maintain compatibility with all browsers and web applications. Thus, in this example, the cookie is named StateID and it contains the anonymous state variable derived in the example described in FIG. 3. The client transmits this value as an http header to web applications to maintain state. As previously discussed, the domain and path fields are empty indicating that the state variable cookie is always valid and the maximum age is set to zero such that the cookie is erased at the end of each browser session.

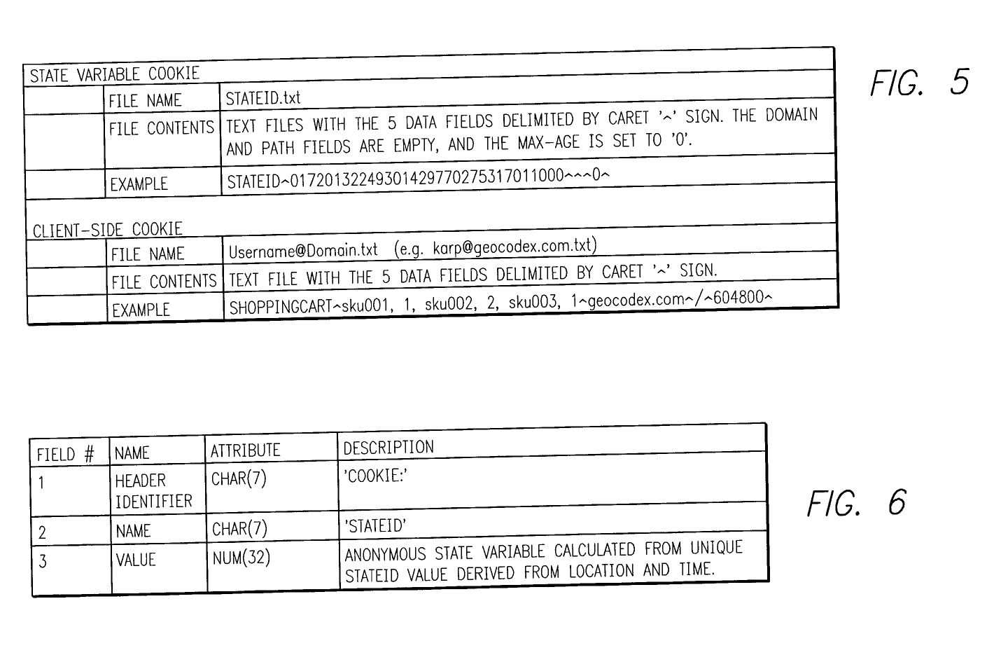

FIG. 6 illustrates a typical http header format that the client uses to transmit information to a server in the state variable cookie implementation. The header contains header identifier, name, and value fields for the state variable cookie. The header identifier field indicates the general contents of the file. In this case, the header identifier indicates that it contains information from a cookie. The name field, as previously discussed, identifies the specific cookie file being transmitted. If the browser has reserved the name StateID for the state variable cookie implementation, then it transmits this name to indicate that it is transmitting a state variable cookie. Finally, the value field contains the anonymous state variable created and stored by the client. Thus, in this example, the client would transmit the http header cookie:StateID=01720132249301429770275317011000 to the server to maintain state. Generally, the client would send this state variable cookie header with every http request. Optionally, the client may only send this header when requested by a server.

FIG. 7 contains a flow chart illustrating a method for maintaining state between a client and server in accordance with an embodiment of the present invention. The flow chart is divided into three general stages: start browser session; browser interactivity; and end browser session. When a user starts a browser session, the browser initializes a new session at step 52. Once a new session is started, the browser retrieves location and temporal values at step 54 from a GPS receiver consistent with an embodiment of the present invention. The browser then generates a unique state variable at step 56 and, if necessary, derives an anonymous state variable from the unique state variable at step 56. The browser stores this state variable for use in the browser interactivity stage.

The user interacts with web applications on various servers during the browser interactivity stage. When the user requests a URL at step 60, the browser parses the URL at step 61 to determine the proper domain and path. For instance, if the URL is http://www.geocodex.com/movies.htm, then the domain is geocodex.com and the path is /. The browser sends the user's request and the state variable cookie in an http header to the target server at step 62. As discussed in connection with FIG. 6 previously, the header contains the state variable created when the browser session was initialized at step 50. Upon receiving the request, the server parses the requested domain and path to determine the information sought by the user. Further, the server matches the received state variable to its database to determine if the user has any continuing transaction pending. The server then sends a response at step 64, which the browser displays to the user at step 66. If the user has enabled the browser to perform operations involving client-side cookies, then the browser parses the server's response for such commands at step 68. For example, the server may request information from a client-side cookie that it had previously stored on the user's system or it may request that such a cookie be created or modified. The user may choose to allow certain servers to maintain client-side cookies.

The user must then decide whether to continue or end the browser session at step 70. The user continues the session by requesting another URL at step 60, which restarts the client-server interaction. However, if the user decides to end the browser session at step 80, then the browser deletes the state variable cookie at step 82 before terminating the session at step 84.

In another embodiment, the state variable cookie is used to make transactions over the Internet more secure. A significant problem with payments conducted over the Internet is fraudulent charge-backs; purchases that are legitimately made using a credit card that the credit card owner later disavows. In such cases, when the credit card owner disavows the charge, the credit card companies generally cancel payment to the seller. Thus, the seller typically bears the cost of any product or service that has already been delivered. In this embodiment, the seller can use the state variable cookie to validate the transaction by specifically identifying the buyer. For example, as long as the seller has sufficient information from the user to decode the state variable, the seller can identify the location of the user's system using the GPS information. While problems will continue to arise for portable systems, sellers may simply require buyers to specify ahead of time a permanent non-public location or zone, such as their homes, from which they will make their purchases.

In another embodiment, the client encrypts all cookies to protect them from unauthorized access either while in storage on the user's system or in transit through public networks. Generally, encryption is the process of encoding information so that only parties knowing the algorithm to decode the message can access the information. Many algorithms for encoding/decoding information currently exist, and any of them can be implemented in this embodiment of the present invention. The cookies may either be encrypted before they are stored on the user's system or they may be encrypted before they are transmitted as an http header or other file to the remote server. Thus, even if an unauthorized party intercepts the cookies during transmission, the information remains unintelligible to anyone except an authorized party.

Finally, in another embodiment, the client generates a unique string of characters to maintain state with web applications. Optionally, it may use a random character generator or a serial number assigned to any component of the system to generate this state variable. The client then uses this unique state variable to maintain state with web applications consistent with the methods previously described.

Having thus described a preferred embodiment of a system and method for maintaining state between a client and server, it should be apparent to those skilled in the art that certain advantages of the invention have been achieved. It should also be appreciated that various modifications, adaptations, and alternative embodiments thereof may be made within the scope and spirit of the present invention. The invention is further defined by the following claims.

What is claimed is:

1. A method for maintaining state between a client and a server, comprising:
generating a state variable including a location value;
utilizing said state variable to maintain state between said client and said server.

2. The method of claim 1, wherein said generating step further comprises generating said location value to correspond to the location of the client.

3. The method of claim 1, wherein said generating step further comprises generating said location value to include a latitude and longitude dimension.

4. The method of claim 3, wherein said generating step further comprises generating said location value to further include an altitude dimension.

5. The method of claim 1, wherein said generating step further comprises generating said state variable to further include a temporal value.

6. The method of claim 5, wherein said generating step further comprises generating said temporal value to correspond to the creation of said state variable.

7. The method of claim 5, wherein said generating step further comprises generating said temporal value to correspond to the invocation of an Internet browser session.

8. The method of claim 1, further comprising the step of deriving an anonymous state variable from said state variable.

9. The method of claim 8, wherein said deriving step further comprises mathematically encoding said state variable into said anonymous state variable.

10. The method of claim 1, wherein said utilizing step further comprises comparing at least a portion of said state variable to a database to identify said client.

11. The method of claim 1, wherein said utilizing step further comprises comparing a portion of said state variable derived from a location value to a database to identify said client.

12. The method of claim 1, wherein said utilizing step further comprises comparing a portion of said state variable derived from a location value corresponding to the location of said client to a database to identify said client.

13. The method of claim 1, wherein said utilizing step further comprises comparing a portion of said state variable derived from a location value comprising a latitude and longitude dimension corresponding to the location of said client to a database to identify said client.

14. The method of claim 1, wherein said utilizing step further comprises comparing a portion of said state variable derived from a location value comprising a latitude, longitude, and altitude dimension corresponding to the location of said client to a database to identify said client.

15. An apparatus for maintaining state between a client and a server, comprising:
means for generating a state variable including a location value;
means for utilizing said state variable to maintain state between said client and said server.

16. The apparatus of claim 16, wherein said location value corresponds to the location of the client.

17. The apparatus of claim 16, wherein said location value comprises a latitude and longitude dimension.

18. The apparatus of claim 17, wherein said location value further comprises an altitude dimension.

19. The apparatus of claim 15, wherein said state variable further includes a temporal value.

20. The apparatus of claim 19, wherein said temporal value corresponds to the creation of said state variable.

21. The apparatus of claim 19, wherein said temporal value corresponds to the invocation of an Internet browser session.

22. The apparatus of claim 15, further comprising means for deriving an anonymous state variable from said state variable.

23. The apparatus of claim 22, wherein said means for deriving an anonymous state variable further comprises means for mathematically encoding said state variable.

24. The apparatus of claim 15, wherein the means for utilizing said state variable to maintain state between said client and said server further comprises means for comparing at least a portion of said state variable to a database to identify said client.

25. The apparatus of claim 24, wherein said portion of said state variable being compared derives from a location value.

26. The apparatus of claim 25, wherein said location value corresponds to the location of said client.

27. The apparatus of claim 25, wherein said location value comprises a latitude and longitude dimension.

28. The apparatus of claim 27, wherein said location value further comprises an altitude dimension.

29. A system for facilitating interaction between a user and a web application on a remote server, comprising:
a computer comprising a processor and memory;
a GPS receiver for generating location values corresponding to said user's geographic location;
means for generating a state variable derived from said location values;
means for utilizing said state variable to maintain state between said user and said web application.

30. The system of claim 29, wherein said computer further comprises said means for generating said state variable and said means for utilizing said state variable.

31. The system of claim 30, wherein said computer further comprises said GPS receiver.
